(19) United States
(12) Patent Application Publication
(10) Pub. No.: US 2006/0198241 A1
(43) Pub. Date: Sep. 7, 2006

(54) Salad dressing mixing and dispensing apparatus

(75) Inventors: Maidam Krishnachaitanya, Pembroke Pines, FL (US); Larry Todd McKinney, Huntersville, NC (US); Albert Hofeldt, Miami Beach, FL (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: H.P. Intellectual Corp.

(21) Appl. No.: 11/072,764

(22) Filed: Mar. 4, 2005

(51) Int. Cl. A47J 43/046

(52) U.S. Cl. 366/205; 366/206; 366/314

(57) ABSTRACT

Embodiments of the present invention relate to a salad dressing mixing and dispensing apparatus. Specifically, a salad dressing mixing and dispensing apparatus in accordance with one embodiment may comprise a blending container, a measuring cup lid having fluid measurement markings and being adapted to fit into a top opening of the blending container, and a base adapted to removably attach to the blending container. The base may house a motor, a power supply, and a manual switch for activating the motor in accordance with some embodiments. Additionally, embodiments may comprise a whisk disposed in the blending container and adapted to couple to the motor in the base such that the motor rotates the whisk within the blending container.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

The combination of oil and vinegar is the basis of many salad dressings. Indeed, a wide variety of salad dressings can be prepared by combining liquid and solid ingredients (e.g., spices) with a basis of oil and vinegar. These salad dressings tend to separate into layers because oil and vinegar are immiscible liquids. Further, the inclusion of additional liquid and solid ingredients may add to the immiscible nature of the salad dressing because of different ingredient densities. For example, insoluble solids may float to the top or sink to the bottom, depending on density. Accordingly, constant mixing may be needed to keep the liquids from separating into layers and to keep solids from settling to the bottom or floating to the top. Indeed, constant mixing of salad dressings including oil and vinegar is often required to maintain consistency.

Preparing salad dressing using existing techniques generally requires the use of a combination of multiple different utensils. For example, salad dressing ingredients may be measured with a set of standard measuring instruments, combined in a container, mixed by shaking, stirring, mixing, or blending, and transferred to a more attractive serving dispenser. The simplest technique may be the manual stirring of a salad dressing in a bowl with a utensil and pouring the contents from the bowl onto the salad without any mechanism for continuously controlling the consistency of the dressing.

There are two typical methods of adding salad dressing to a salad. The first method may be to add the entire amount of prepared dressing to the salad—a method that insures that the proportions of the ingredients are as intended. However, this first method has the disadvantage of necessitating preparation of dressing for each salad or requiring use of an entire bottle of commercial dressing for each salad. This method may be practical for large salads that are entirely consumed at one meal, but impractical for small or individual salads. The second method may be to pour a sample of the prepared dressing onto a salad. This method may be ideal for small to medium sized salads where pouring the entire bottle of dressing would be excessive and uneconomical. Pouring multiple samples of the dressing has the convenience of using a prepared dressing over an extended period of time. However, this second method may result in disproportionate dressing ingredients on each salad.

One deficiency of existing technologies is the difficulty in maintaining a uniform dispersion of salad dressing ingredients during pouring. This is due to the time-dependent separation of the components (e.g., oil and vinegar). For example, in the time it takes to remove a cap or to remove a power mixer, the mixture may begin to separate into layers and the solid matter may begin to settle or rise. Options for avoiding this problem may be to pour quickly (before the mixture separates into components) or to pour slowly and accept a poorly mixed sample. Pouring quickly, in addition to being an inconvenience, may result in spillage and so forth. Pouring slowly may result in the mixture not being uniformly dispersed (e.g., first samples may contain an excessive amount of oil while later samples will have an excessive amount of vinegar). Indeed, as more samples are poured slowly, the residual mixture may become more disproportionate and no one sample will be representative of the initial desired mixture.

In addition to difficulty in maintaining uniform dispersion of salad dressing ingredients, existing technologies may be deficient because they result in disorder during preparation and cleanup. For example, existing techniques generally require the use of multiple utensils to prepare salad dressing such as measuring cups, measuring spoons, stirrers, whisks, serving containers and so forth. Therefore, existing techniques may require cleaning of a large number of utensils after preparation. It should also be noted that existing techniques may require the use of a recipe book, which may add to the disorder. A user of existing techniques may be required to spend excessive amounts of time accumulating the necessary items and then cleaning them individually after use. Further, some items may not be easily cleaned because of problems associated with contacting water, which can damage an electric motor for example.

### BRIEF DESCRIPTION OF THE DRAWINGS

FIG. 1 is a partial cross-sectional view of a salad dressing mixing and dispensing apparatus in accordance with an embodiment of the present invention;

FIG. 2 is a partially exploded cross-sectional view of a salad dressing mixing and dispensing apparatus in accordance with an embodiment of the present invention;

FIG. 3 is a view of a blending container of the salad dressing mixing and dispensing apparatus taken along line 3-3 of FIG. 2 in accordance with an embodiment of the present invention;

FIG. 4 is a view of a blender base of the salad dressing mixing and dispensing apparatus taken along line 4-4 of FIG. 2 in accordance with an embodiment of the present invention;

FIG. 5 is a circuit diagram illustrating switch operation in accordance with an embodiment of the present invention; and

FIGS. 6A and 6B are views of an exemplary tilt switch which may be utilized in the blender base in accordance with an embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The techniques described herein relate to salad dressing mixing and dispensing that maintains consistency of ingredients and facilitates preparation and cleaning. Indeed, several adaptations in accordance with exemplary embodiments may overcome known deficiencies in the prior art. For example, exemplary embodiments are adapted to mix salad dressing ingredients to a uniform dispersion prior to outflow and to automatically initiate mixing upon pouring. Such techniques avoid problems with inconsistency and enable the uniform dispersion of representative samples of salad dressing in desired quantities. Additionally, various components for making salad dressing (e.g., blending vessel, measuring cup, automatic mixer, list of ingredients) may be grouped into a single multi-module utensil. Such a utensil may facilitate salad dressing preparation and reduce required cleaning time. Further, cleaning may be facilitated because each component of an exemplary apparatus that is adapted to contact food may be submersible in water for cleaning.

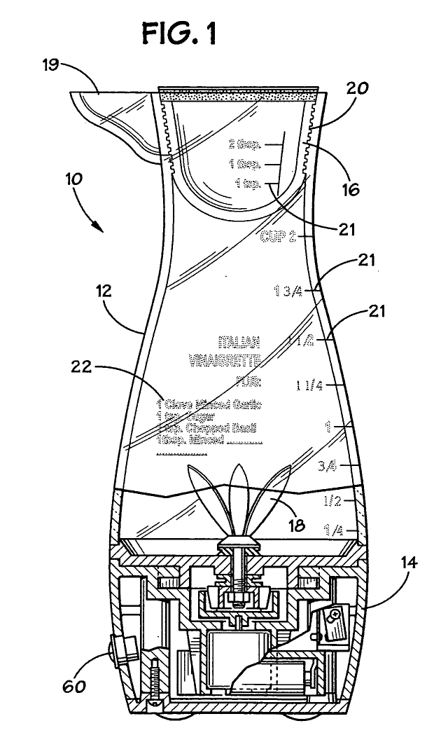

FIG. 1 illustrates a salad dressing mixing and dispensing apparatus in accordance with an exemplary embodiment. The entire apparatus may generally be referred to as blender 10. The blender 10 may include a plurality of components that are assembled into a single unit. Specifically, FIG. 1 illustrates a fully assembled blender 10 having a blending container 12, a base 14, a measuring cup lid 16, and a whisk 18. Each of these components will be discussed in further detail below.

The blending container 12 may be constructed of various materials, including shatterproof materials to prevent accidental breakage and materials that are easily cleaned (e.g., plastic). Further, the blending container 12 may have various different shapes that improve functionality (e.g., facilitate pouring, facilitate mixing, and increase structural strength) and/or that improve aesthetic qualities of the blender 10. For example, the blending container 12 may have a generally cylindrical shape with a varying diameter such that the container constricts in the middle. This may provide added control while pouring, give the blender a more elegant appearance, and so forth. In alternative embodiments, the blending container 12 may comprise a basic cylinder, an elongate box shape, and so forth. Indeed, various different shapes may be used to facilitate use (e.g., cleaning and storage) and to provide a stylish appearance. In one embodiment, the blending container 12 includes a spout 19 protruding from the top lip of the container 12 to facilitate pouring.

The blending container 12 and base 14 may be constructed of plastic materials having a similar coefficient of expansion so that breakage will not occur when cooled during refrigeration. The measuring cup lid 16 may also be constructed of similar material. In some embodiments, the measuring cup lid 16 may be formed of comolded rubber or may include a seal (e.g., an O-ring), such that the measuring cup lid 16 will fit securely in the opening at the top of the blending container 12 creating a seal. In another embodiment, the measuring cup lid 16 may fit around the periphery of outer portions of the top of the blending container 12. In still other embodiments, the measuring cup lid 16 may have threads 20 that cooperate with threads in the opening at the top of the blending container 12 to create a seal. For example, in one embodiment of the present invention, the measuring cup lid 16 is removable by twisting the measuring cup lid 16 to disengage the threads 20. Further, partial removal of the measuring cup lid 16 may provide access to pouring through the spout 19 protruding from the top of the blending container 12. Indeed, the spout 19 may be formed such that partial removal of the measuring cup lid 16 allows liquid to pass only through the spout 19.

Both the blending container 12 and the measuring cup lid 16 may be marked with information such as index marks 21 and text 22. These index marks 21 may relate to fluid levels in the cup lid 16 and container 12 and may facilitate the measuring of ingredients for a wide variety of salad dressings and other mixtures. For example, the index marks 21 on the measuring cup lid 16 may be used to measure individual ingredient amounts to be poured into the blending container 12. The index marks 21 on the container 12 may then be used to confirm that the ingredients have been combined in appropriate quantities (e.g., confirm that the total volume is appropriate). The index marks 21 may be incremented in accordance with standard measurements (e.g., cups, quarter cups, and tablespoons). Alternatively, the index marks 21 may correspond to text 22 relating to specific recipe quantities and preparation procedures (e.g., “Add oil to the first index mark and then add vinegar to the second index mark.”).

The text 22 may comprise recipes or information relating to preparation of various types of salad dressings and so forth. Indeed, text 22 may be supplied near the index marks 21 corresponding to specific ingredients and may be color coded for different recipes. For example, certain index marks 21 and text 22 may be colored red for French dressing and certain other index marks 21 and text 22 may be colored white for Italian dressing. Additionally, as discussed above, text 22 corresponding to a list of ingredients may be situated near certain index marks such that a user can prepare the desired dressing merely by adding the ingredient amounts indicated by the text 22 and the index marks 21. For example, if a recipe first calls for one cup of vinegar and then one cup of oil, the one cup index marker may correspond to vinegar and the two cup marker may correspond to oil.

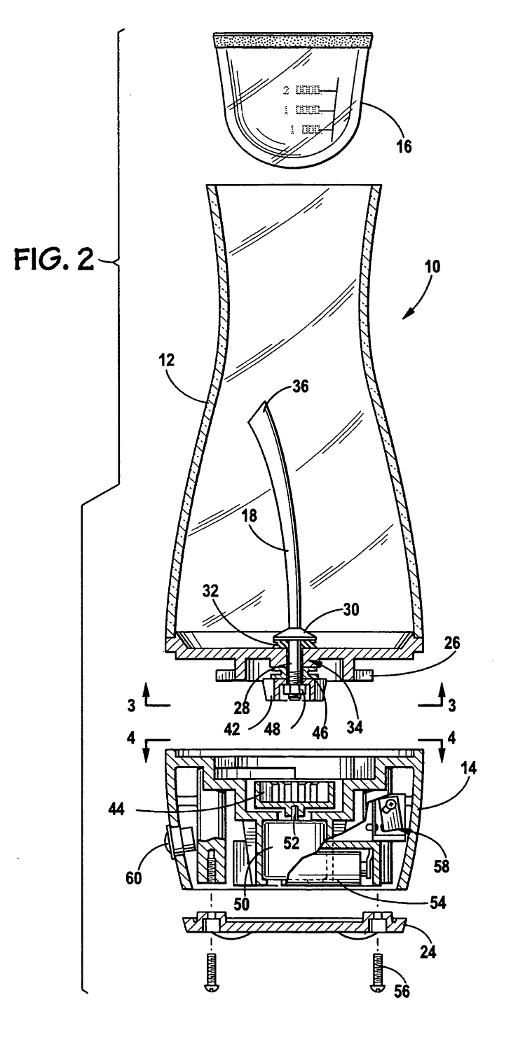

FIG. 2 is a partially exploded cross-sectional view of an exemplary salad dressing mixing and dispensing apparatus. Specifically, FIG. 2 illustrates the blender 10 with the blending container 12 separated from the base 14. Additionally, the measuring cup lid 16 and a bottom cover 24 are shown in removed positions. This exploded view illustrates that the components shown in FIG. 2 may be removably coupled to one another by various different means (e.g., bayonet mounts, wedging, screws, etc.). It should be noted that this ability to removably couple components in some embodiments, as illustrated by FIG. 2, may facilitate cleaning, replacement of batteries, repair, and so forth.

The blending container 12 may be removably coupled to the base 14, so that a motor in the base 14 can drive the whisk 18 in the blending container 12 to mix ingredients together. While other methods of attachment may be used, in the illustrated embodiment, the blending container 12 is adapted to be secured to the base 14 by bayonet mounts 26. The bayonet mounts 26, which project from the bottom of the blending container 12, may be utilized to interlock the blending container 12 with the base 14. In the interlocked position, a base portion 28 of the whisk 18 which extends downwardly from a protective lip 30 of the whisk 18 may pass through a first seal 32 into the base 14 through an opening 34. It should be noted that in one embodiment of the present invention, the bayonet mounts 26 project from the base 14 instead of the blending container 12 and are adapted to couple with corresponding female parts in the blending container 12. This arrangement facilitates flattening the bottom of the blending container 12 to allow for stabilization when the blending container 12, separated from the base 14, is placed on a surface.

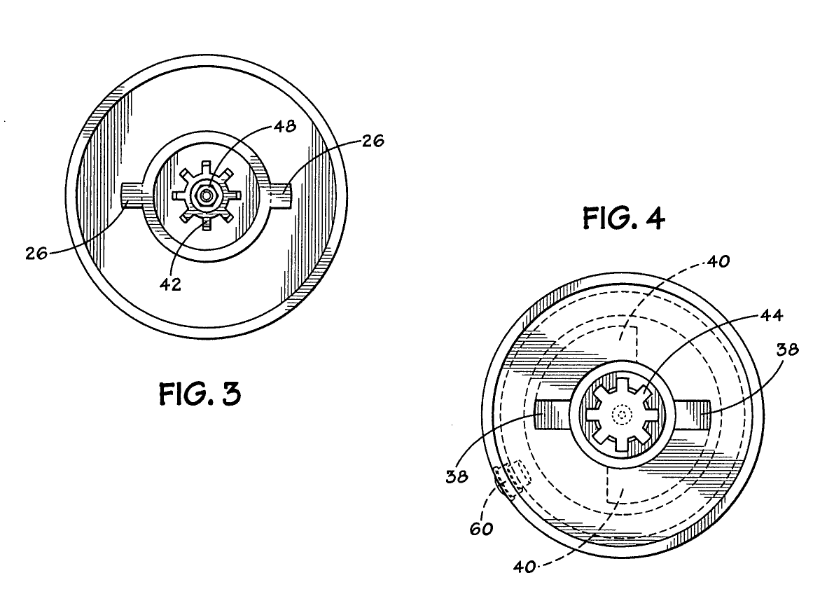

FIGS. 3 and 4 are views of the blender 10 along lines 3-3 and 4-4. FIG. 3 illustrates an upward view from the bottom of the blending container 12 and FIG. 4 illustrates a downward view from the top of the base 14. These figures illustrate how the blending container 12 and base 14 can be removably coupled and how rotational energy can be transferred from the motor 50 in the base 14 to the whisk 18. Specifically, FIG. 3 shows bayonet mounts 26 that are adapted for insertion into slots 38 in base 14, as shown in FIG. 4. Upon insertion into base 14, the blending container 12 may be rotated to secure the bayonet mounts 26 in grooves 40 and thus secure the blending container 12 to the base 14. In this secured position, blades 42, which are attached to the whisk 18, may couple with a gear 44 in the base 14 to facilitate transfer of rotational energy from the motor 50 in the base 14 to the whisk 18. As the gear 44 turns, the blades 42 will turn and the whisk will rotate correspondingly.

The whisk 18 may take various forms and utilize various alternative material compositions. For example, the whisk 18 may include rigid blades (e.g., plastic or metal blades) and a rotor as shown in FIG. 1. Alternatively, the whisk 18 may be a single shaft formed of a flexible material (e.g., acetal resin), as shown in FIG. 2. Indeed, the whisk 18 may be adapted such that it can be coupled to the base 14 in a cantilevered position with a weighted end 36 opposite the base 14, such that the flexible material allows the weighted end 36 to move outwardly when rotated. Centrifugal force may deviate the out-of-balance apex and cause the flexible whisk 18 to spin in a conical path, which quickly stirs the mixture. Additionally, because the protective lip 30 may be made of a flexible material (e.g., acetal resin), it may operate with the first seal 32 to prevent salad dressing, water, and other liquids and mixtures from entering into the base portion 14 of the blender 10. The seal 32 may be made of rubber or constructed of some other material (e.g., soft plastic), such that it can be used to make an airtight closure.

The base 14 may comprise various components for coupling to the whisk 18 and transferring rotational energy to the whisk 18 without allowing leakage between the blending container 12 and the base 14. For example, a second seal 46, which may be constructed of material similar to that of the first seal 32, may be disposed beneath the blending container 12 and adapted to receive the base portion 28 of the whisk 18, thus providing additional leak protection. In the illustrated embodiment, the base portion 28 passes through the second seal 46 into the blades 42 that are coupled to the whisk 18 by a bolt 48. As discussed above, the blades 42 may be coupled to the gear 44 in the base 14, thus connecting the whisk to a blender motor 50 via a motor shaft 52, which is coupled to the gear 44. The motor 50 rotates the whisk 18 for mixing of ingredients in the blending container 12. The base 14 may house a power source for the motor 50, such as batteries 54. Access to the batteries 54 may be provided by bottom cover 24 when screws 56 are removed. Further, the base 14 may house switch mechanisms for activating the motor 50 such as a tilt switch 58 and a manual on/off switch 60. The motor 50 may be powered by the batteries 54 or an AC adapter and may be activated by the tilt switch 58 and/or the manual on/off switch 60.

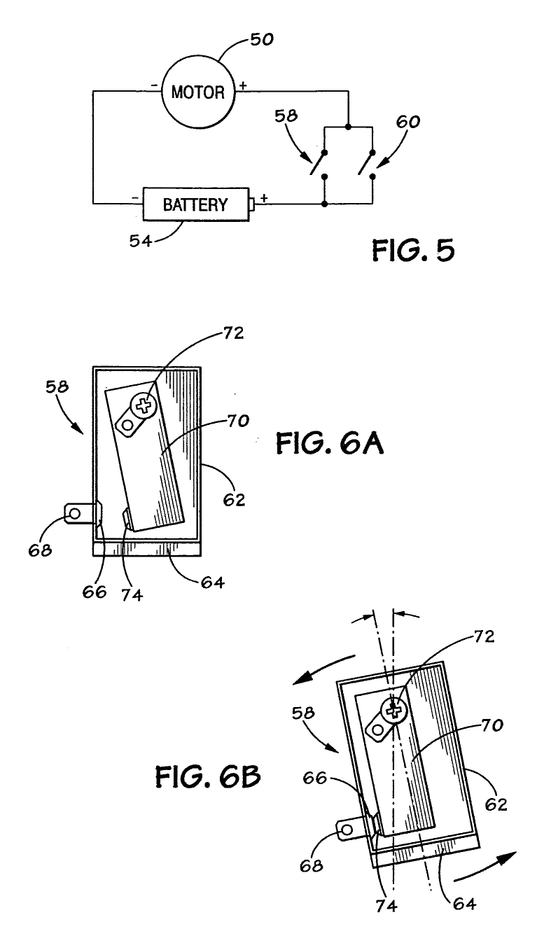

FIG. 5 is a circuit diagram illustrating switch operation in accordance with an exemplary embodiment. The dual switches enable mixing during preparation and constant mixing during pouring. This constant and thorough mixing may prevent layer separation during pouring and facilitate pouring of a representative sample. The manual on/off switch 60 can be used during preparation and prior to pouring to establish mixture consistency. The tilt switch 58 may enable automatic mixing throughout the period of pouring because the switch will be engaged when the blender 10 is tilted. In some embodiments, the whisk 18 may turn at a higher or lower rate of speed depending on which of the two switches is activated. For example, the manual on/off switch 60 may have a first rotation speed setting that activates the motor 50 at a certain rotation speed to facilitate mixing, and the tilt switch 58 may have a second rotation rotation speed setting that activates the motor at a slower rotation speed to maintain the mixture without causing spillage. In some embodiments, the speed settings for manual and automatic/tilt mixing may each be variable. Additionally, one switch may override the other. For example, when the blender 10 is in a tilted position, the tilt switch 58 may override the manual on/off switch 60 to prevent undesired results.

FIGS. 6A and 6B illustrate views of an exemplary tilt switch 58. FIG. 6A illustrates the tilt switch 58 in a non-tilted position, such as when the blender 10 is in an upright position. FIG. 6B illustrates the tilt switch 58 in a tilted position, such as when salad dressing is being poured from the blender 10. The tilt switch 58 may include a non-conductive enclosure 62 having a base 64 and a contact plate 66, which is connected to an electrical connector 68. The electrical connector 68 may link with the motor 50, thus supplying power to the motor 50 when the base is in a tilted position. The tilt switch 58 may include a conductive bar 70 that is disposed within the non-conductive enclosure 62 and that is connected to the enclosure 62 by bolt assembly 72. The bolt assembly 72 allows for rotation of the metal bar 70 within the non-conductive enclosure 62 such that a contact point 74 disposed at a bottom portion of the metal bar 70 will meet the contact plate 66 when the blender 10 is tilted for pouring. While various different tilt switches may be utilized, the illustrated embodiment demonstrates that power can be provided to the motor 50 from the batteries 54 or an AC adapter (not shown) through the switch 58 to enable mixing during pouring.

The blender 10 may be utilized by removing the measuring cup lid 16 and using it to fill the blending container 12 with appropriate ingredients. The measuring cup lid 16 may then be replaced and the ingredients may be mixed by manually pressing the manual on/off switch 60. When the user is satisfied that the ingredients are sufficiently mixed, the user may begin to pour samples of the mixture onto individual salads. While pouring, the blender 10 may be tilted, thus causing the tilt switch 58 to engage and connect power from the power supply (e.g., battery) to the motor 50. While the tilt switch 58 is engaged, the whisk 18 may turn at a designated rotation speed that is fast enough to ensure consistency while pouring but slow enough to prevent spillage (e.g., 30 rpm).

The blender 10 may be cleaned by first removing the blending container 12 from the base 14. This may be achieved by twisting the base 14 to unfasten the bayonet mounts 26 from the container 12. Each portion of the blender 10 that contacted food may then be submersed in water and cleaned with soap. Because the first seal 32, the second seal 46, and the whisk 18 may operate to prevent the mixture from leaking into the base 14, it is generally unnecessary to wash the base 14. The entire upper portion of the blender 10, on the other hand, can be completely submersed for cleaning. Specifically, the entire upper portion may include the blending container 12, the measuring cup lid 16, the whisk 18, and so forth.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A salad dressing mixing and dispensing apparatus, comprising:
a blending container;
a measuring cup lid having fluid measurement markings, the measuring cup lid adapted to fit into a top opening of the blending container;
a base adapted to removably attach to the blending container, the base housing a motor, a power supply, and a manual switch for activating the motor;
a whisk disposed in the blending container and adapted to couple to the motor in the base such that the motor rotates the whisk within the blending cup.

2. The apparatus of claim 1, comprising a protective lip above a base portion of the whisk, the protective lip adapted to cooperate with a seal to prevent leakage between the blending container and the base, the base portion adapted to pass through the seal and couple to a motor.

3. The apparatus of claim 2, wherein the base portion of the whisk is adapted to couple to the motor through a coupling device.

4. The apparatus of claim 1, comprising a tilt-switch adapted to provide power to the whisk when the base is tilted.

5. The apparatus of claim 4, wherein the tilt-switch is adapted to engage the motor in a first mode of rotation and the manual switch is adapted to engage the motor in a second mode of rotation having a different speed than the first mode of rotation.

6. The apparatus of claim 4, wherein the manual switch and tilt-switch have variable speeds.

7. The apparatus of claim 1, wherein the blending container, measuring cup lid, and whisk comprise waterproof material.

8. The apparatus of claim 1, wherein the blending container and base are formed from materials with similar coefficients of expansion.

9. The apparatus of claim 1, comprising text disposed on the blending container, the text relating to recipes for products that can be prepared in the salad dressing mixing and dispensing apparatus.

10. The apparatus of claim 1, comprising index marks disposed on the blending container, the index marks corresponding to standard fluid measurements.

11. The apparatus of claim 1, comprising index marks and text disposed on the blending container, the index marks in conjunction with the text providing specific ingredient measurements for a recipe.

12. The apparatus of claim 1, comprising color coded text disposed on the blending container, the color coded text relating to a plurality of recipes for products that can be prepared in the salad dressing mixing and dispensing apparatus.

13. The apparatus of claim 1, comprising a spout protruding from a top portion the blending container, the spout adapted to facilitate fluid flow upon partial removal of the measuring cup lid.

14. A salad dressing mixing and dispensing apparatus, comprising:
a blending container;
a base adapted to attach to the blending container, the base housing a motor, a power supply, a tilt-switch for activating the motor when the base is in a tilted position, and a manual switch for activating the motor manually, the tilt-switch having a first rotation speed setting and the manual switch having a second rotation speed setting different from the first rotation speed setting;
a whisk disposed in the blending container and adapted to couple to the motor in the base such that the motor rotates the whisk within the blending container.

15. The apparatus of claim 14, wherein the blending container and the base are formed from materials with similar coefficients of expansion.

16. The apparatus of claim 14, wherein the blending container and the whisk are waterproof.

17. The apparatus of claim 14, comprising a sealing assembly that incorporates a bottom portion of the whisk to prevent leakage between the blending container and the base while facilitating transfer of rotational energy from the motor to the whisk.

18. The apparatus of claim 14, wherein the whisk comprises a shaft of a flexible material.

19. The apparatus of claim 14, wherein the manual switch and tilt-switch have variable speed settings.

20. The apparatus of claim 14, comprising color coded text on a measuring cup lid adapted to facilitate recipe preparation, the measuring cup lid adapted to fit into a top opening of the blending container.

21. The apparatus of claim 14, comprising index marks and text disposed on the blending container, the index marks in conjunction with the text providing specific ingredient measurements for a recipe.

22. The apparatus of claim 14, comprising a measuring cup lid formed of rubber and adapted to fit into a top opening of the blending container to form a seal, the measuring cup lid having index marks corresponding to standard fluid measurements.

23. The apparatus of claim 14, comprising a spout protruding from a top portion the blending container, the spout adapted to facilitate fluid flow upon partial removal of a lid, the lid adapted to fit into a top opening of the blending container.
